(19) United States
(12) Patent Application Publication
(10) Pub. No.: US 2005/0011366 A1
(43) Pub. Date: Jan. 20, 2005

(54) Cotton candy machine toy

(75) Inventors: Charles Joseph Kowalski, Ridgewood, NJ (US); Parviz Daftari, Summit, NJ (US); C. K. Lo, Mongkok (HK); Keung Kang Wong, Kowloon Bay (HK); Lawrence I. Rosen, Mendham, NJ (US)

Correspondence Address: McCarter & English, LLP, Four Gateway Center, 100 Mulberry Street, Newark, NJ, 07102, US

(73) Assignee: Rose Art Industries, Inc.

(21) Appl. No.: 10/761,645

(22) Filed: Jan. 20, 2004

Related U.S. Application Data
(60) Provisional application No. 60/441,510, filed on Jan. 20, 2003.

(51) Int. Cl. A23L 1/00

(52) U.S. Cl. 99/331

(57) ABSTRACT

The cotton candy machine includes a base and a bowl attached thereto. A spinner is included for rotating sugar as well as a heating assembly for heating sugar which falls on a plate of the spinner. A cap is also provided and is attached to the spinner. The cotton candy machine is also equipped with various safety devices. For example, an interlock safety switch is used to indicate whether the bowl has been removed from the cotton candy machine while the cotton candy machine is in operation. A reed switch/magnet arrangement is utilized to detect whether the cap has been removed from the cotton candy machine. Sensors are provided to detect mechanical malfunctions. Thermostats are also employed to monitor and to sense an overheat condition in the cotton candy machine.

### CROSS-REFERENCE TO RELATED APPLICATION

This is a non-provisional application relating to commonly owned co-pending U.S. Provisional Application Ser. No. 60/441,510 filed Jan. 20, 2003, the disclosure of which is incorporated herein by reference.

### FIELD OF THE INVENTION

The present invention relates to cotton candy machines and, more particularly, to a cotton candy machine adapted for use as a toy.

### BACKGROUND OF THE INVENTION

In order to make cotton candy, granular sugar is heated in a revolving chamber referred to as a spinner. The liquefied sugar is rotated by the spinner, which forces the sugar through a narrow aperture formed in the spinner. As the sugar passes through the narrow aperture, a strand of sugar referred to as floss is formed.

While conventional cotton candy machines are effective for their intended use, they are not designed for use as a toy due to safety issues. For example, one safety issue relates to the temperature required to heat the granulated sugar. This temperature is well above the threshold of skin burn and pain. Accordingly, there is a need for a cotton candy machine that addresses such safety issues before allowing access to children.

### SUMMARY OF THE INVENTION

A new and improved cotton candy machine includes a base and a bowl attached thereto. The base includes a spinner sized and shaped so as to rotate and a heating assembly for heating the spinner. A cap is also provided and is attached to the spinner. The cotton candy machine is also equipped with various safety devices. For example, an interlock safety switch is used to indicate whether the bowl has been removed from the cotton candy machine while the cotton candy machine is in operation. A reed switch/magnet arrangement is utilized to detect whether the cap has been removed from the cotton candy machine.

Other safety devices include a sensor for detecting whether (1) the cotton candy machine has malfunctioned, (2) the spinner has ceased to rotate, and (3) the spinner is included in the cotton candy machine. Thermostats are also employed to monitor and to sense an overheat condition in the cotton candy machine. An actuator is provided to prevent the cotton candy machine from operating for than a predetermined time. A cool down mechanism provides continued air circulation even when the cotton candy machine is shut off.

### BRIEF DESCRIPTION OF THE DRAWINGS

For a more complete understanding of the present invention, reference is made to the following detailed description of exemplary embodiments considered in conjunction with the accompanying drawings, in which:

FIG. 1 is an exploded, perspective view of a cotton candy machine, equipped with a base and a bowl, constructed in accordance with a first embodiment of the present invention;

FIG. 2 is a cross-sectional view, taken along section line II-II and looking in the direction of the arrows, of the cotton candy machine in its assembled state shown in FIG. 1;

FIG. 3 is a partial cross-sectional view, taken along section line III-III and looking in the direction of the arrows, of the cotton candy machine shown in FIG. 2;

FIG. 4 is an enlarged view of a heating assembly shown in FIG. 3;

FIG. 5 is partial cross-sectional view of the cotton candy machine shown in FIG. 1, and equipped with a spinner and a sensor;

FIG. 6 is a schematic view, partially shown in section, of the spinner and the sensor shown in FIG. 5;

FIG. 7 is a schematic view, partially shown in section, of the spinner of FIG. 5 as well as a light source and a receiver;

FIG. 8 is a partial cross-sectional view of the base of FIG. 1;

FIG. 9 is a schematic view of the electrical circuit utilized in the cotton candy machine of FIG. 1;

FIG. 10 is an exploded, perspective view of a cotton candy machine, equipped with a base and a bowl, constructed in accordance with a second embodiment of the present invention;

FIG. 11 is a cross-sectional view, taken along section line XI-XI and looking in the direction of the arrows, of the cotton candy machine in its assembled state shown in FIG. 10;

FIG. 12 is a partially cross-sectional view of the base of FIG. 11;

FIG. 13 is partial cross-sectional view of the cotton candy machine shown in FIG. 11 and equipped with a hub assembly; and

FIG. 14 is an enlarged view of the hub assembly.

### DETAILED DESCRIPTION OF THE EXEMPLARY EMBODIMENTS

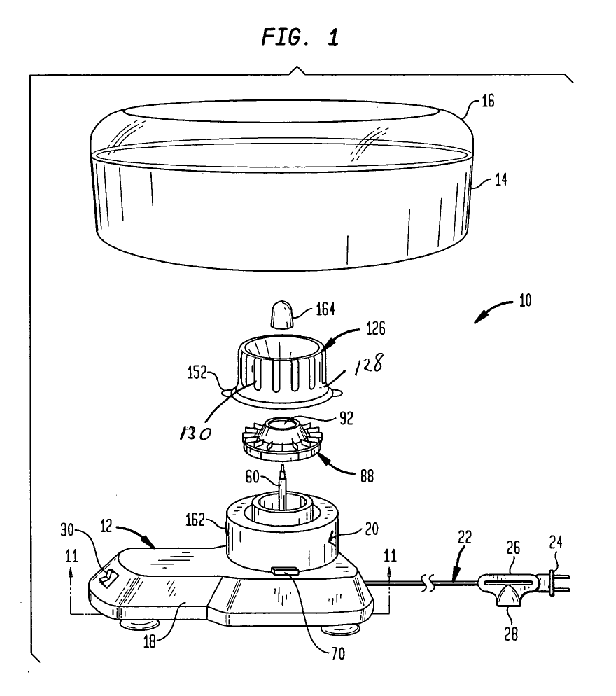

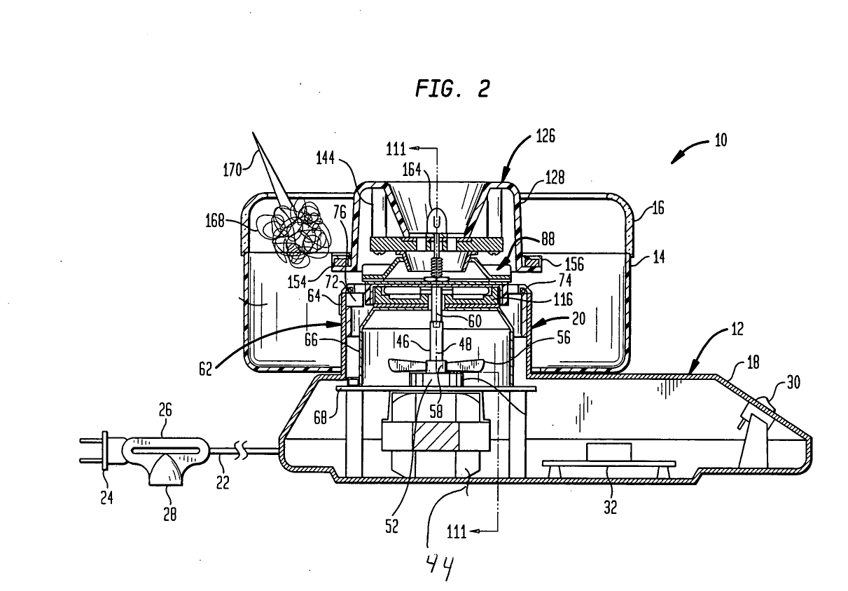

FIGS. 1-9 illustrate a cotton candy machine 10 constructed in accordance with a first embodiment of the present invention. With particular reference to FIGS. 1 and 2, the cotton candy machine 10 includes a base 12 and a bowl 14 removably mounted to the base 12. The bowl 14 includes a shield 16 attached thereto. Referring to FIGS. 1-3, the base 12 includes a housing 18 and a main assembly 20 connected thereto.

The housing 18 is equipped with an electrical cord 22 (see FIGS. 1 and 2) having a plug 24 through which power is provided to the cotton candy machine 10. The electrical cord 22 includes a mating tool 26 attached to the plug 24. The mating tool 26 has an opening 28 formed therein for reasons to be described hereinafter. A conventional on/off switch 30 is also provided on the housing 18.

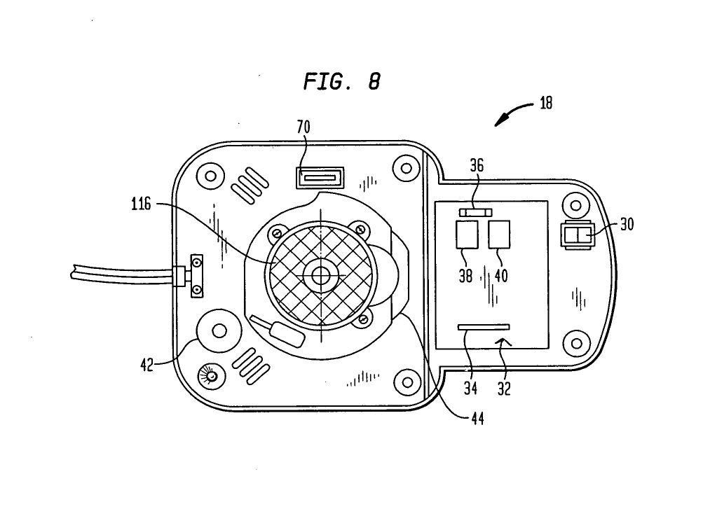

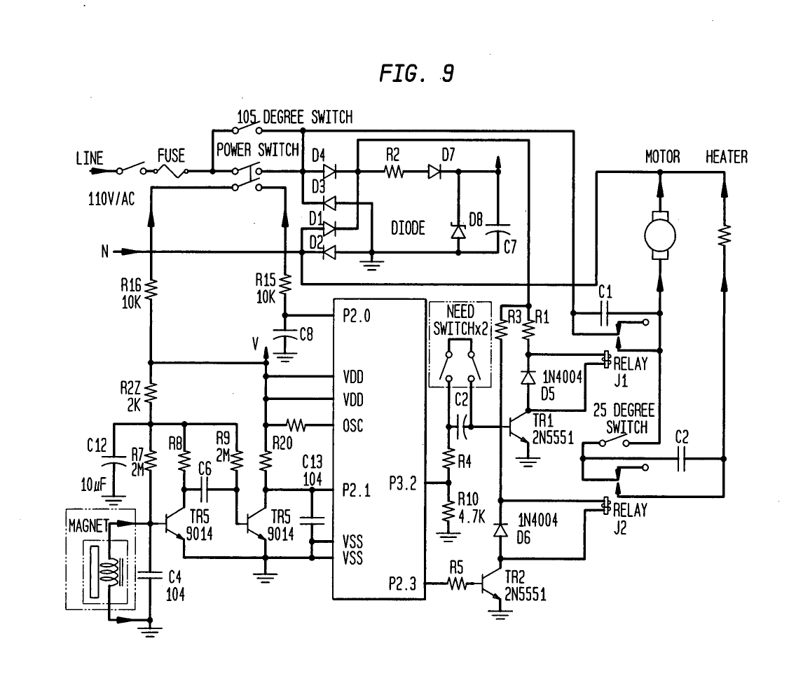

Referring to FIG. 8, the housing 18 is sized and shaped so as to contain various electrical components (shown schematically) therein, the circuitry itself being depicted in FIG. 9. More particularly, the housing 18 contains a circuit board 32 and an electrical process controller 34 mounted to the circuit board 32. The controller 34 is a time based logic device that controls the operation of the cotton candy machine 10.

A fuse 36 contained within the circuit board 32 is provided to terminate power to the cotton candy machine 10 in the event of an electrical failure, such as a short circuit. The fuse 36 may be non-resetable. A pair of electrical relays 38, 40 through which power is transmitted is also contained within the circuit board 32. The housing 18 also contains a speaker 42 which may be either a piezo-electric device or conventional cone speaker.

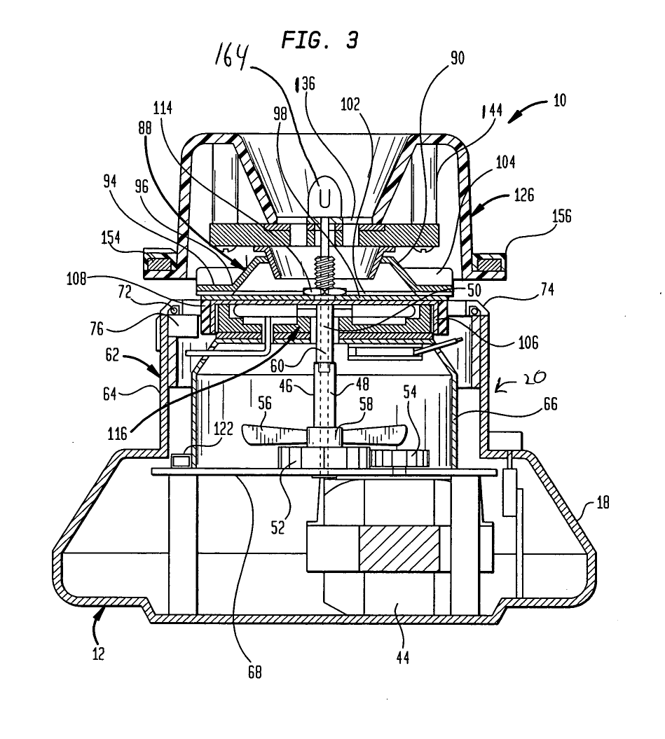

Referring to FIGS. 2 and 3, a motor 44 is contained within the housing 18. The motor 44 is electrically connected to the circuit board 32 (see FIG. 8) and to the on/off switch 30 (see FIGS. 1 and 2). A rotatable shaft 46 is connected to the motor 44 and sized and shaped so as to revolve when the motor 44 is activated. The rotatable shaft 46 includes a proximal end 48 located adjacent to the motor 44 and a distal end 50 (see FIG. 3). A bearing 52 is attached to the proximal end 48 of the rotatable shaft 46, while a bearing 54 (see FIG. 3) is attached to the bearing 52 and to the motor 44. A cooling fan 56 is also mounted to the rotatable shaft 46 via a lock ring 58 and is utilized for purposes to be described hereinafter. A stationary shaft 60 is sized and shaped so as to be coaxially received within the rotatable shaft 46.

The main assembly 20 includes a support member 62 having an outer peripheral wall 64 and an inner bracket 66, each of which is attached to the housing 18. The inner bracket 66 includes a platform 68 connected to the housing 18.

With reference to FIG. 1, an interlock safety switch 70 is situated adjacent to the main assembly 20. The interlock safety switch 70 is sized and shaped so as to mate with the bowl 14. The interlock safety switch 70 is electrically connected to the controller 34 (see FIG. 8), and is normally in an electrically “closed” state. As will be explained in further detail hereinafter, the interlock safety switch 70 can be used to indicate whether the bowl 14 has been removed from the cotton candy machine 10 while in operation.

As shown most clearly in FIG. 5, the support member 62 includes a pair of reed switches 72, 74 spaced 180 degrees apart. The reed switches 72, 74 are magnetically operated and sensitive, each of which having switch contacts (not shown) encapsulated in an evacuated glass envelope (not shown). The reed switches 72, 74 are connected in serial fashion and are electrically connected to the controller 34 (see FIG. 8), and are normally in an electrically “closed” state. According to an arrangement that will be described in further detail hereinafter, the reed switches 72, 74 detect whether a particular component (i.e., a cap to be discussed below) of the cotton candy machine 10 has been removed.

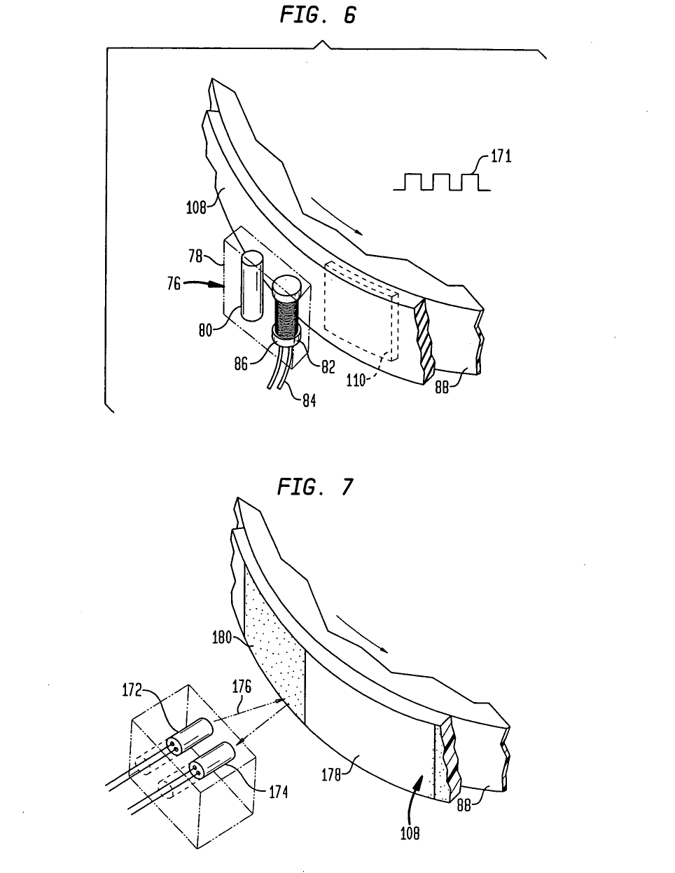

A sensor 76 is provided within the support member 62 and is located below the reed switch 72. Referring to FIG. 6, the sensor 76 includes a cover 78, a permanent magnet 80, and a coil 82 composed of fine copper wire 84 wound around a ferrite spool 86. As will be described in further detail hereinafter, the sensor 76 is employed for various reasons, such as to detect whether the cotton candy machine 10 has malfunctioned.

With reference to FIGS. 1-3 and 5-7, the cotton candy machine 10 includes a spinner 88 received within the main assembly 62 (see FIGS. 1-3). The spinner 88 is sized and shaped so as to rotate when the rotatable shaft 46 rotates. More particularly, the spinner 88 includes a cup 90 (see FIGS. 3 and 5) with a center opening 92 (see FIG. 1) and an edge 94 (see FIGS. 3 and 5) extending radially outwardly from a proximal end 96 of the cup 90.

Referring to FIGS. 3 and 5, a plate 98 is provided below the edge 94 of the spinner 88 for receiving granulated sugar 100 (see FIG. 5). Narrow openings 102 are formed between the edge 94 and the plate 98 for purposes to be described hereinafter. A plurality of fins 104 is mounted to the edge 94 for generating air flow. With particular reference to FIG. 5, the spinner 88 also includes an aluminum ring 106 extending downwardly from the plate 98 and permanently attached thereto. A heat resistant elastomer insulating band 108 for retaining heat is sized and shaped so as to cover the perimeter of the aluminum ring 106.

With reference to FIGS. 5 and 6, the aluminum ring 106 includes a pair of steel plates 110, 112, each of which being covered by the insulator band 108. The steel plates 110, 112 cooperate with the sensor 76 located in the housing 18 for purposes to be described hereinafter. The component parts of the spinner 88 are securely attached with a retaining nut 114 (see FIG. 5).

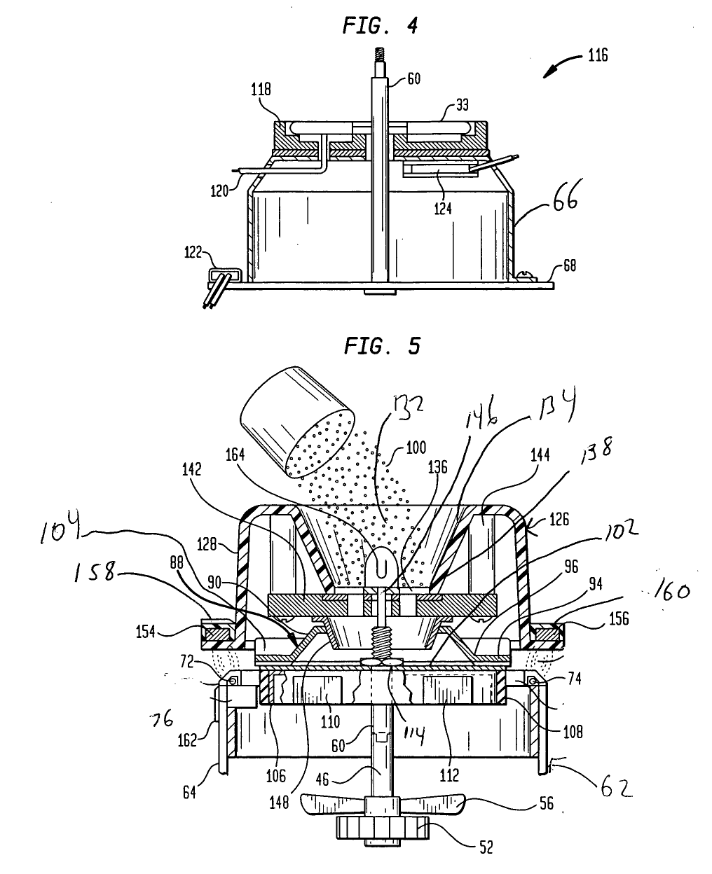

Referring to FIGS. 2 and 3, a heater assembly 116 is provided and is positioned adjacent to and below the plate 98 of the spinner 88. As more clearly shown in FIG. 4, the heater assembly 116 is contained within the inner bracket 66 of the support member 62, and includes a heater element 118 and a heater filament or wire 120 connected to the heater element 118. The heater element 118 is utilized to provide heat to the spinner 88 through convention and radiation.

A first thermostat 122 is positioned below the heater element 118 and situated adjacent the platform 68. The thermostat 122 is rated 75 degrees Celsius and has normally closed contacts (not shown), which are electrically connected to the primary power source. The thermostat 122 is employed to monitor and to sense an overheat condition in the cotton candy machine 10 such that if the temperature in the base 12 reaches 75 degrees Celsius, power to the cotton candy machine 10 shuts off.

The cotton candy machine 10 also includes a second thermostat 124 positioned within the heater assembly 116. The thermostat 124 is rated is 105 degrees Celsius and has normally open contacts. When the temperature in the cotton candy machine 10 reaches 105 degrees Celsius, the thermostat is adapted to close. The thermostat 124 is utilized to cool the cotton candy machine 10. More particularly, when the on/off switch 30 (see FIGS. 1 and 2) is turned “on”, the thermostat 124 will close as heat is generated. When the on/off switch 30 is shut “off”, the thermostat 124 will remain closed and no heat will be produced by the heater element 118 as the motor 44 (see FIGS. 2 and 3) continues to rotate, thereby forcing cool air upwards by means of the fan 56 (see FIG. 5). Heat will be dissipated away from the heated components and after the thermostat 124 falls to a lower temperature, the thermostat 124 will open, thereby terminating electrical power to the cotton candy machine 10. The cool down period can be from three minutes to ten minutes depending on the temperature of the cotton candy machine 10 and the ambient temperature.

As illustrated in FIGS. 1-3 and 5, the cotton candy machine includes a cap 126 positioned above the spinner 88. The cap 126 has an external housing 128 (see FIG. 1) equipped with a plurality of air vents 130 extending vertically upwards. As most clearly shown in FIG. 5, the cap 126 has a center opening 132 communicating with the center opening 92 (see FIG. 1) of the spinner 88. The interior of the cap 126 has a cone-shaped wall 134 and a perforated screen 136 attached to a proximal end 138 of the wall 134. The perforated screen 136 is mounted to the stationary shaft 60 via an opening (not shown) formed therein. Openings (not shown) formed in the perforated screen 136 have a predetermined size so as to limit the amount of sugar 100 falling therethrough. The cap 126 can be made from any thermally insulating material, such as a thermosetting or thermoplastic polymer, for maintaining the external housing 128 at a safe temperature.

A metal heat sink 142 (see FIG. 5) is sized and shaped so as to capture the perforated screen 136 and is connected to the external housing 128 via a pillar 144. The metal heat sink 142 has a “D” shaped hole (not shown) sized and shaped to mate with a distal section 146 of the stationary shaft 60 which has a corresponding “D” shape. The heat sink 142 serves to remove excessive heat from the stationary shaft 60 and can be constructed with spokes (not shown) or fins (not shown) for improved heat dissipation. A funnel 148 is attached to a proximal end 150 of the heat sink 142 and is in communication with the center opening 92 of the spinner 88 and with the center opening 132 of the cap 126.

As most clearly shown in FIG. 5, the cap 126 also has a rim 152 (see FIG. 1) which includes a pair of magnets 154, 156 spaced 180 degrees apart and contained within molded magnet caps 158, 160, respectively, extending from the rim 152. A front direction of the cap 126 is designated by an arrow (not shown) atop the magnet cap 158 so as to align with the arrow 162 formed in the support member 62. The magnets 154, 156 communicate with the reed switches 72, 74 to detect whether the cap 126 has been removed from the cotton candy machine 10. When the cap 126 is properly aligned with the stationary shaft 60, the magnets 154, 156 are positioned directly above the reed switches 72, 74 of the support member 62 so as to create a magnetic flux field through an air gap, thereby electrically closing the reed switches 72, 74. In an electrically closed state, the reed switches 72, 74 allow the cotton candy machine 10 to operate. When the cap 126 is removed from the stationary shaft 60, the reed switches 70, 72 are electrically open, thereby preventing the cotton candy machine 10 from operating.

With reference to FIGS. 1-3 and 5, a nut 164 is connected to a distal end 166 of the stationary shaft 60 and serves to lock the cap 126 thereto. The lock nut 164 has a shape which prevents the lock nut 164 from being removed by an user's hand. The lock nut 164 is sized and shaped so as to mate with the opening 28 (see FIGS. 1 and 2) of the mating tool 26. More particularly, the lock nut 164 can only be removed when the opening 28 in the mating tool 26 engages the nut 164. Because the mating tool 26 is positioned adjacent the electrical plug 24 (see FIGS. 1 and 2), the electrical plug 24 has to be removed from an outlet (not shown) in order for the mating tool 26 to engage the lock nut 164. Accordingly, the lock nut 164 cannot be removed while the cotton candy machine 10 is in operation. In the event that the lock nut 164 is loosen and removed with a device other than the mating tool 26 and the cap 126 is lifted off the stationary shaft 60, the reed switches 72, 74 electrically open, thereby sounding an audible alarm through the speaker 42 (see FIG. 8).

In operation, the electrical plug 24 (see FIGS. 1 and 2) is inserted in an outlet and the on/off switch 30 is turned on. When the cotton candy machine 10 is turned on, the spinner 88 automatically rotates in a counter clockwise direction. As the spinner 88 rotates, the plate 98 thereof is heated by the heating element 118 to a temperature, which is dependent on the wattage generated and the ambient temperature. The wattage generated preferably ranges between 130 and 180 watts.

With reference to FIG. 5, the granulated sugar 100 is delivered into the cotton candy machine 10 through the opening 132 in the cap 126. The granulated sugar 100 then flows through the openings (not shown) formed in the perforated screen 136, which serves to limit the amount of sugar 100 passing therethrough, and through the funnel 148. Thereafter, the granulated sugar 100 falls on the plate 98 of the rotating spinner 88.

After liquefying on the heated plate 98 of the spinner 88, the liquefied sugar is forced by centrifugal force through narrow apertures 102 formed in the spinner 88 and into the bowl 14 (see FIG. 2). As a result, floss 168 (see FIG. 2) is formed. The floss 168 is then collected in the bowl 14 and the shield 16 which aids in forming floss 168 by retaining heat within the bowl 14. A paper cone 170 (see FIG. 2) can be used to remove the floss 168 from the cotton candy machine 10.

In the event that excessive floss 168 is formed, the motor 44 (see FIGS. 2 and 3) may jam and stop. If the motor 44 stops, power to the cotton candy machine 10 will be terminated and an alarm will sound through the speaker 42.

During operation, the spinner 88 may stop rotating due to various reasons (e.g., excessive floss accumulation, insertion of a foreign object into the spinner 88, mechanical failure, etc.). In this regard and with reference to FIG. 6, the sensor 76 located within the support member 62 and the steel plates 110, 112 located within the spinner 88 cooperate to detect whether the spinner 88 has ceased to rotate or whether the spinner 88 is not installed in the cotton candy machine 10. The sensor 76 and the steel plates 110, 112 are positioned relative to each other such that the steel plates 110, 112 can be detected by the sensor 76 when the spinner 88 rotates. More particularly, when the spinner 88 rotates, the steel plates 110, 112 rotate about the support member 62, thereby creating a magnetic field. When the steel plates 110, 112 are detected by the sensor 76, a change in magnetic field occurs, thereby creating an electromotive force and a pulse signal 171, in this case, approximately 50 pulses per second. This pulse signal 171 is then transmitted to the process controller 34 (see FIG. 8). If the process controller 34 does not receive this pulse signal 171, power to the cotton candy machine 10 will be terminated. The time interval between the cessation of the spinner 88 and the termination of electrical power is approximately one to two seconds. In one embodiment, the spinner 88 normally rotates at 4,500 revolutions per minute creating about 150 pulses per second. Pulse time need not be critical as the controller 34 is programmed for a wide range of input signals.

Referring to FIG. 7, an optical infrared filtered light source 172 and a receiver 174 can be employed rather than the sensor 76 and the steel plates 110, 112 to detect whether the spinner 88 has ceased to rotate or whether the spinner 88 is not installed in the cotton candy machine 10. In this embodiment, the light source 172 and the receiver 174 are located within the support member 62 and are positioned adjacent to the spinner 88. The insulating band 108 of the spinner 88 is painted or molded alternatively in black and white to create a pulse signal as the spinner 8 passes the light source 172 and the receiver 174. The infrared light source 172 directs a continuous beam of red light 176 onto the spinner 88 as it rotates such that the beam 176 is reflected off a white section 178 of the insulator band 108 into the receiver 174, thereby creating a pulse signal. This pulse signal is then transmitted to the process controller 34. When the beam 176 emitted from the light source 172 is absorbed by a black section 180 of the insulating band 108, no pulse signal is generated. If the process controller 34 does not receive this pulse signal, power to the cotton candy machine 10 will be terminated. This optical method may also operate in the visible region of the spectrum.

If the cotton candy machine 10 is operating after a predetermined period of time (e.g., thirty minutes), the controller 34 is programmed to sound an alarm. If no action is taken by a user in response to the alarm, power to the heating assembly 116 will be terminated so as to prevent an overheat condition. The motor 44 and the fan 56 will continue to rotate, forcing cool air upward to lower the temperature of the cotton candy machine 10 for approximately five to ten minutes. If the user is present when the alarm is heard and desires more floss 168 (see FIG. 2), the user will move the on/off power switch 30 to the “off” position and then back to the “on” position in order to reset the time base controller 34, thereby allowing the cotton candy machine 10 to operate for an additional predetermined period of time. The selection of thirty minutes is not critical and other time periods can be utilized.

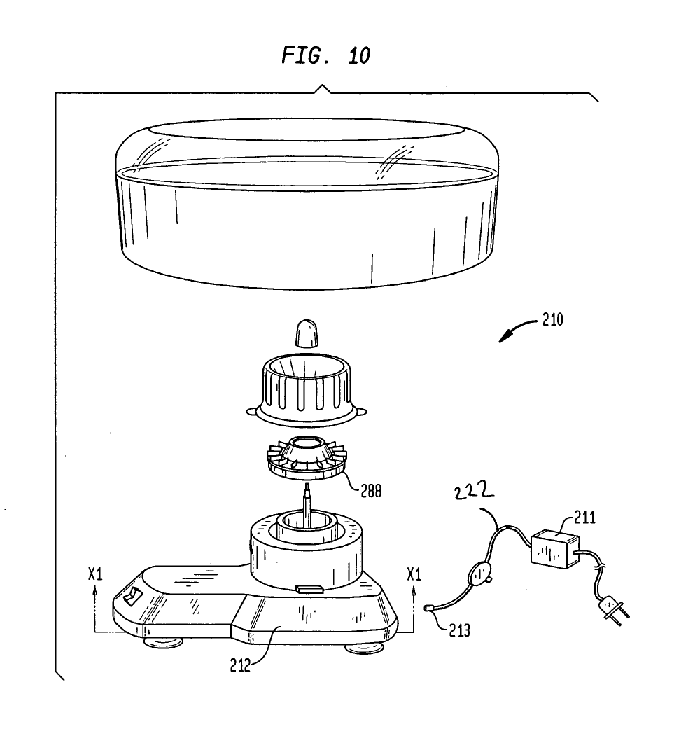

Another exemplary embodiment of the present invention is illustrated in FIGS. 10-14. Elements illustrated in FIGS. 10-14 which correspond to the elements described above with reference to FIGS. 1-9 have been designated by corresponding reference numerals increased by two hundred. In addition, elements illustrated in FIGS. 10-14 which do not correspond to the elements described above with reference to FIGS. 1-9 have been designated by odd numbered reference numerals starting with reference number 211. The embodiment of FIGS. 10-14 operates in the same manner and provides the same basic advantages as the embodiment of FIGS. 1-9, unless it is otherwise stated.

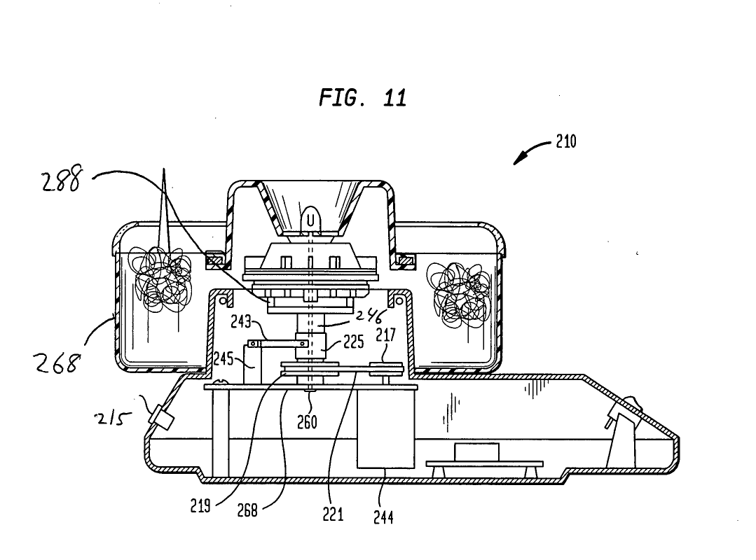

FIGS. 10-14 show a cotton candy machine 210 that can operate at a voltage other than that supplied in the United States. With particular reference to FIG. 10, the cotton candy machine 210 is equipped with a power supply 211, such as a frequency switching supply or a conventional transformer step down device, adapted to reduce the voltage. More particularly, the power supply 211 is adapted to reduce the voltage to 24 volts or less. Accordingly, the cotton candy machine 210 can operate at a lower voltage than the cotton candy machine 10. The power supply 211 is attached to an electrical cord 222 which has an end 213 sized and shaped to mate with a receptacle 215 (see FIG. 11) located on a base 212.

With reference to FIG. 11, the cotton candy machine 210 includes a fixed pulley 217 and a rotating pulley 219 with a belt 221 connecting the pulleys 217, 219. The fixed pulley 217 is attached to a motor 244, while the rotating pulley 219 is attached to a rotatable shaft 246. A stationary shaft 260 is coaxially received within the rotatable shaft 246. In this manner, power is transmitted from the motor 244 to the rotatable shaft 246 via the pulley and belt arrangement.

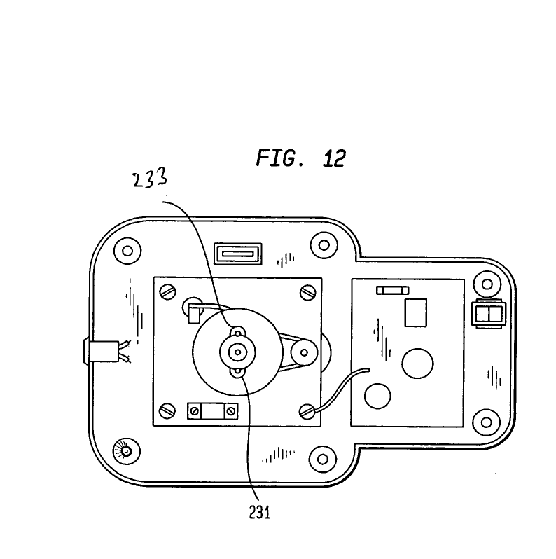

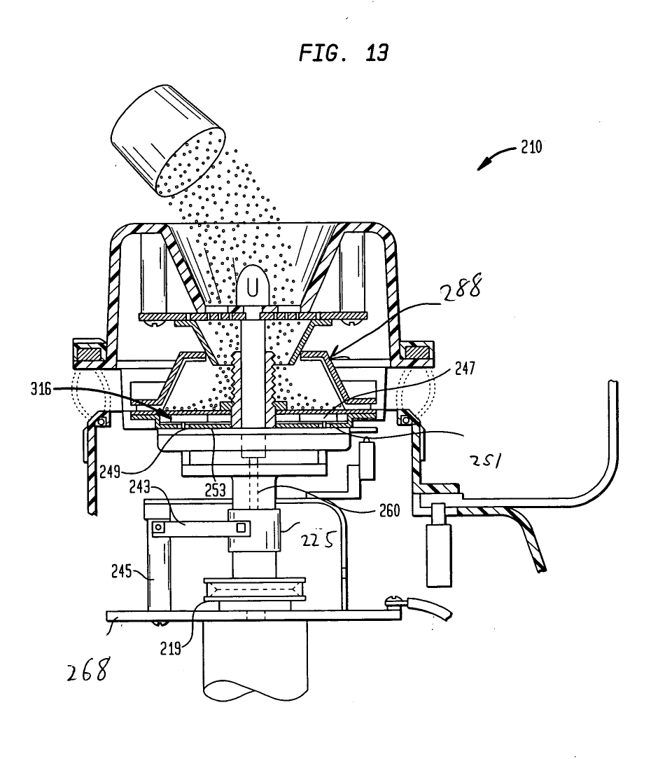

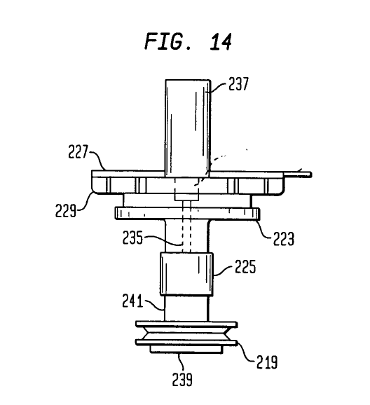

Referring to FIG. 14, a hub 223 is provided which includes an electrically conductive band 225 which is made of a material, such as copper, that has low resistance. The hub 223 is sized and shaped so as to rotate. An insulated stand 227 is situated above and permanently fastened to the hub 223. The stand 227 includes radial spokes 229 sized and shaped so as to provide air flow for improving floss creation. The stand 227 also includes a pair of recesses (not shown) which contain electrical sockets 231, 233 (see FIG. 12) of the same polarity, through which power is directed to a spinner 288 (see FIG. 13), which has a construction and operation similar to the spinner 88.

A copper strap 235 is attached to the copper band 225 and projects upward into the stand 227 through an opening (not shown) formed therein, electrically attached to the electrical socket 231. The stand 227 and the hub 223 are aligned and supported by a metallic bearing 237 which bears a flange 239 at its proximal end 241 to support the insulated hub 223. The bearing 237 is constructed with a bore (not shown) rotatably mounted to the stationary shaft 260 (see FIG. 13).

With reference to FIGS. 11 and 13, the cotton candy machine 210 includes an electrically conductive arm 243 which is used to transmit electrical power to the hub 223. The arm 243 is composed of brass metal and a lubricious electrically conductive material such as carbon. Conductive materials other than carbon may be employed. An insulating post 245 is used to isolate the arm 243 from a platform 268 of a support member 262. The power supply has an electrical line (not shown) attached to an end of the arm 243. When the arm 243 contacts the copper band 225, power is transmitted to a heater assembly 316. Another electrical line of opposite polarity is fastened to the platform 268 for transmitting power through the metallic bearing 237 (see FIG. 14). The stand 227, through the connector socket 231, completes the circuit.

Referring to FIG. 13, a PTC device 247 for generating heat is provided which includes connector pins 249, 251. The connector sockets 231, 233 are used to transfer electrical power to the PTC device 247 through the connector pins 249, 251 fastened thereto. The PTC device 247 is insulated by insulating films 253. The PTC device 247 has self-limiting temperature characteristics.

It should be appreciated that the cotton candy machines 10, 210 provides numerous benefits and advantages. For instance, each of the cotton candy machines 10, 210 is adapted for improved safety.

It will be understood that the embodiments described herein are merely exemplary and that a person skilled in the art may make many variations and modifications without departing from the spirit and scope of the invention. For instance, although the spinner 88 rotates at 4,500 revolutions per minute, the spinner 88 can rotate at 3,000 revolutions per minute or greater. The heating assembly 116 can employ thick film technology rather than the heater filament 120. The ring 106 can be made of any suitable ferrous metal. Although a pair of reed switches 72, 74 is shown, the cotton candy machine 10 can be equipped with only one of the reed switches 72, 74. All such variations and modifications, including those discussed hereinabove, are intended to be included within the scope of the invention as defined in the appended claims.

1. A toy cotton candy machine comprising:
a) a base with a drive motor and an upwardly extending fixed shaft, a primary power switch, a power cord and a power plug;
b) a bowl engaging the base by securement means including a detent;
c) a spinner enclosed within a stationary, insulating top cap, the top cap held in place on the shaft by a lock nut;
d) a time-based logic controller adapted to control a plurality of machine functions; and
e) a heater adapted to supply heat to the spinner,
the machine further comprising at least one structural safety feature and at least one operational safety feature.

2. A device of claim 1 in which the at least one structural safety feature is a member selected from the group consisting of:
a) a first sensor adapted to detect proper installation of the top cap;
b) a second sensor adapted to detect proper installation of the bowl;
c) the lock nut having a removal-resistant first shape;
d) a removal tool with an aperture conformal with the first shape and affixed to the power cord immediately adjacent to the power plug; and
e) a third sensor adapted to detect proper installation of the spinner, and
in which the at least one operational safety feature is a member selected from the group consisting of:
i) a first thermostat situated within the base and adapted to serve as a primary power interrupt if the base reaches an overheat temperature;
ii) a third sensor adapted to detect rotation of the spinner, produce a rotation signal an transmit the rotation signal to the logic controller;
iii) a first function programmed within the logic controller to actuate a power interrupt and actuate an audible alarm at a first preselected time interval after the power switch is actuated;
iv) a second function programmed within the logic controller to maintain rotation of the spinner for a second preselected time interval after power to the heater is interrupted;
v) a third function programmed within the logic controller adapted to actuate the audible alarm when at least one of the sensors has indicated a machine fault; and
vi) a fuse adapted to serve as a primary power interrupt in the event of a catastrophic electrical fault within the machine.

3. A device of claim 2 comprising a plurality of the structural safety features.

4. A device of claim 3 comprising all of the structural safety features.

5. A device of claim 2 comprising a plurality of the operational safety features.

6. A device of claim 5 comprising all of the operational safety features.

7. A device of claim 2 comprising a plurality of the structural safety features and a plurality of the operational safety features.

8. A device of claim 2 comprising all of the structural safety features and all of the operational safety features.

9. A device of claim 2 in which the third sensor comprises a light source and a light detector.

10. A device of claim 9 in which the light source emits infrared light and the light detector detects infrared light.

11. An electrically activated device comprising:
a) an operational unit;
b) a protective cover adapted to prevent a user from contacting the operational unit;
c) a power cord and a power plug adapted to energize the operational unit;
d) a lock nut with a removal-resistant shape adapted to hold the protective cover in place; and
e) a removal tool with an aperture conformal with the removal-resistant shape,
wherein the removal tool is affixed to the power cord immediately adjacent to the power plug, whereby the power plug must be unplugged in order to permit the removal tool to remove the lock nut.
